(19) United States
(12) Patent Application Publication
(10) Pub. No.: US 2022/0332394 A1
(43) Pub. Date: Oct. 20, 2022

(54) METHOD AND SYSTEM OF BALLASTING AND DEBALLASTING A VESSEL

(71) Applicant: PHOENIX II A/S, Copenhagen (DK)

(72) Inventors: Frederik SMIDTH, Kokkedal (DK); Mads Lykke ANDERSEN, Gentofte (DK)

(73) Assignee: PHOENIX II A/S, Copenhagen (DK)

(21) Appl. No.: 17/697,102

(22) Filed: Mar. 17, 2022

(30) Foreign Application Priority Data
Apr. 14, 2021 (DK) PA 2021 00377

(51) Int. Cl. B63B 35/00; B63B 13/00; B63B 77/00; B63B 1/10

(52) U.S. Cl. CPC B63B 35/003; B63B 13/00; B63B 77/00; B63B 1/107

(57) ABSTRACT

A method of ballasting a vessel comprises positioning a vessel having a first draft adjacent to or underneath an offshore installation. The vessel has at least one ballasting tank and at least one port in fluid communication with the at least one ballasting tank. The at least one ballasting tank is arranged to selectively adjust the flow of ballast water in and out of the at least one ballasting tank. The method comprises pushing down from the offshore installation on the vessel to increase the draft of the vessel from the first draft to a second draft. The method further comprises opening the at least one port when the vessel is at the second draft and the at least one port is below a waterline. The method also comprises filling at least part of the at least one ballasting tank.

### TECHNICAL FIELD

The present disclosure relates to a method and system of ballasting and deballasting a vessel. In particular, the present disclosure relates to a method and system of ballasting and deballasting a vessel with an offshore installation.

### BACKGROUND

In the offshore industry operations are performed from specialised platforms or vessels, known colloquially as “rigs”. Multiple types of rig exist, such as fixed platforms, jack-ups, semi-submersibles, ships, barges, and the like. The particular type of rig used can depend on a number of factors, such as water depth, rig availability, operational requirements, and the like.

Offshore jack-up rigs can be used for different purposes. Some offshore jack-up rigs are used to drill and extract oil and gas. Alternatively, offshore jack-up rigs can be used for building and maintaining other offshore installations such as offshore wind turbine generators.

Offshore wind turbine generator installation can be carried out in separate stages. One current method of installation is to anchor a foundation to the seabed using a monopile foundation. A transition piece is fixed to the monopile foundation and the transition piece projects out of the water. The offshore wind turbine generator is then fixed to the transition piece. The offshore installation can provide a suitable worksite for installing offshore wind turbine generator.

One known method of installing wind turbine generators is disclosed in WO20201200379. This discloses pushing down on a barge from a jack-up in order to limit relative motion between the barge and the jack-up. A problem with this arrangement is that when the cargo is removed from the barge, the barge in no longer fully laden. This means that when the barge is released, the barge floats higher in the water. This means that in some circumstances the barge can clash with the hull of the jack-up after unloading the cargo.

### SUMMARY

Examples of the present disclosure aim to address the aforementioned problems.

According to an aspect of the present disclosure there is provided a method of ballasting a vessel comprising: positioning a vessel having a first draft adjacent to or underneath an offshore installation, the vessel having at least one ballasting tank and at least one port in fluid communication with the at least one ballasting tank arranged to selectively adjust the flow of ballast water in and out of the at least one ballasting tank; pushing down from the offshore installation on the vessel to increase the draft of the vessel from the first draft to a second draft; opening the at least one port when the vessel is at the second draft and the at least one port is below a waterline; and filling at least part of the at least one ballasting tank.

Optionally, the at least one port is above the waterline when the vessel is at the first draft.

Optionally, the method comprises lifting off a first cargo from the vessel after the pushing down.

Optionally, the method comprises placing a second cargo on the vessel after the filling.

Optionally, the second cargo is lighter than the first cargo.

Optionally, the filling comprises filling the at least one ballasting tank until the weight of second cargo and the at least one ballasting is the same as the weight of the first cargo.

Optionally, the filling comprises removing air from the at least one ballasting tank.

According to another aspect of the present disclosure there is provided a method of deballasting a vessel having at least one ballasting tank and at least one port in fluid communication with the at least one ballasting tank arranged to selectively adjust the flow of ballast water in and out of the at least one ballasting tank, the method comprising: removing downward force on the vessel exerted by an offshore installation positioned above or near the vessel; raising the vessel from a second draft to a first draft due to a buoyancy force on the vessel; opening the at least one port when the vessel is at the first draft; and emptying at least some of the at least one ballasting tank.

Optionally, the opening the at least one port comprises opening the at least one port when the at least one port is below a waterline.

Optionally, the emptying the at least one ballasting tank is in part in dependence of hydrostatic pressure of the ballast water in the at least one ballasting tank.

Optionally, the emptying comprises suppling air into the at least one ballasting tank.

Optionally, the method comprises raising the vessel to a third draft smaller than the first draft wherein the at least one port is above a waterline when the vessel is at a third d raft.

Optionally, when the vessel is at the third draft an air draft of the vessel is greater than a clearance between the waterline and an underside of the offshore installation.

Optionally, the emptying comprises flow rate of the ballast water of between 0.25 m³/s to 3 m³/s.

Optionally, the duration of the emptying is between 900 s to 7200 s.

Optionally, the method comprises pumping ballast water out of the at least one ballasting tank.

According to another aspect of the present disclosure there is provided a system for ballasting a vessel having a first draft comprising: an offshore installation having: a securing mechanism arranged to push down on the vessel and increase the draft of a vessel from the first draft to a second draft; and a vessel having: at least one ballasting tank; and at least one port in fluid communication with the at least one ballasting tank arranged to selectively adjust the flow of ballast water in and out of the at least one ballasting tank; wherein the at least one port is arranged to be below a waterline when the vessel is at the second draft and arranged to fill the at least part of the at least one ballasting tank.

According to another aspect of the present disclosure there is provided a system for deballasting a vessel having a first draft comprising: an offshore installation having: a securing mechanism arranged to push down on the vessel and increase the draft of a vessel from the first draft to a second draft; and a vessel having: at least one ballasting tank; and at least one port in fluid communication with the at least one ballasting tank arranged to selectively adjust the flow of ballast water in and out of the at least one ballasting tank; wherein when the securing mechanism disengages from the vessel the vessel is arranged to rise from the second draft to the first draft and when the vessel is at the first draft the at least one port is arranged to empty at least part of the at least one ballasting tank.

According to another aspect of the present disclosure there is provided a variable draft vessel comprising: a deck arranged to receive a securing mechanism mounted on an offshore installation arranged to push down on the vessel and increase the draft of a vessel from the first draft to a second draft; at least one ballasting tank; and at least one port in fluid communication with the at least one ballasting tank arranged to selectively adjust the flow of ballast water in and out of the at least one ballasting tank; wherein the at least one port is arranged to be below a waterline when the vessel is at the second draft and arranged to fill the at least part of the at least one ballasting tank.

According to another aspect of the present disclosure there is provided a variable draft vessel comprising: a deck arranged to receive a securing mechanism mounted on an offshore installation arranged to push down on the vessel and increase the draft of a vessel from the first draft to a second draft; at least one ballasting tank; and at least one port in fluid communication with the at least one ballasting tank arranged to selectively adjust the flow of ballast water in and out of the at least one ballasting tank;

wherein when the securing mechanism disengages from the vessel the vessel is arranged to raise from the second draft to the first draft and when the vessel is at the first draft the at least one port is arranged to empty at least part of the at least one ballasting tank.

### BRIEF DESCRIPTION OF THE DRAWINGS

Various other aspects and further examples are also described in the following detailed description and in the attached claims with reference to the accompanying drawings, in which:

FIG. 1 shows a side view of an offshore installation and a vessel according to an example;

FIG. 2 shows a schematic front cross-sectional view of a vessel along the axis A-A according to an example;

FIGS. 3 to 11 show a front view of an offshore installation and a vessel at different stages of a method according to an example;

FIGS. 12 and 13 show a close-up schematic view of the vessel according to different stages of a method according to an example; and

FIGS. 14 and 15 show a flow diagram of a method according to an example.

### DETAILED DESCRIPTION

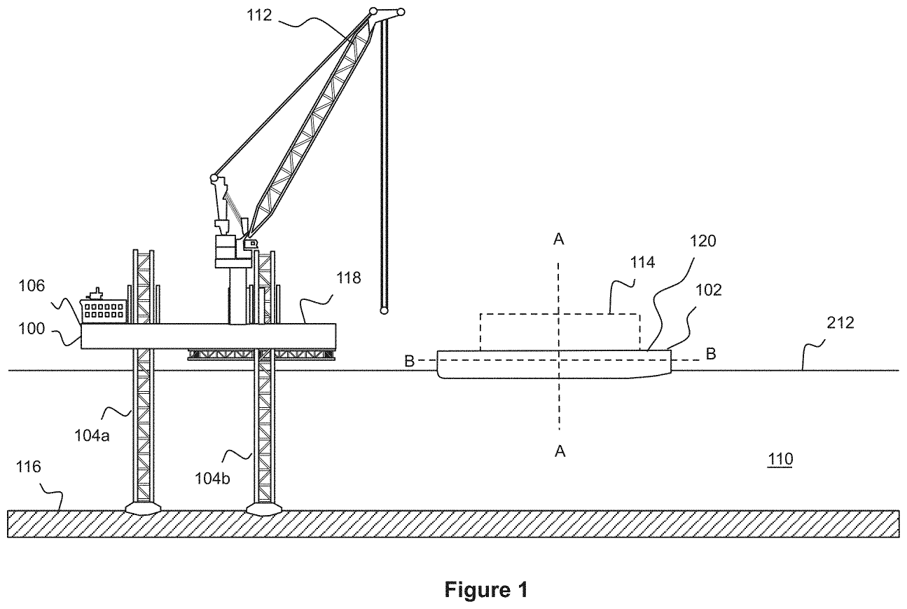

FIG. 1 shows a side view of an offshore installation 100 and a vessel 102 according to an example. In some examples, the offshore installation 100 is a jack-up rig.

However, the methods and apparatus discussed below can be used with other offshore installations and other forms of jack-up equipment such as jack-up vessels or jack-up barges.

In some examples, any form of offshore installation 100 and any form of vessel 102 may be utilised using the ballasting and deballasting method described below. However, for the illustrative purposes only, the accompanying Figures describe a jack-up offshore installation 100. Hereinafter the terms “offshore installation” 100 will be used when describing the examples in the accompanying Figures.

In some examples, the offshore installation 100 is fixed to the seafloor 116. For example, as shown in FIG. 1, the offshore installation 100 comprises a plurality of a legs 104a, 104b, extending from an offshore installation hull 106 and are fixed to the seafloor 116. The plurality of legs 104a, 104b, can be fixed with respect to the offshore installation hull 106. In other examples and as shown in FIG. 1, the plurality of legs 104a, 104b are moveable e.g. the offshore installation 100 is a jack-up.

In some further alternative examples, the offshore installation 100 can be floating and not fixed to the seafloor 116. For example, the offshore installation 100 can be a semi-submersible rig or vessel. In other examples, the offshore installation 100 can be a floating dock.

Turning back to FIG. 1, the examples of the offshore installation 100 having the plurality of legs 104a, 104b fixed to the seafloor 116 will be discussed in more detail. In some examples, the moveable legs 104a, 104b are open truss legs, but in other examples the moveable legs 104a, 104b are solid cylindrical legs. The moveable legs 104a, 104b extend downwardly through the offshore installation hull 106 via respective jacking mechanisms (not shown). The operation of raising and lowering the offshore installation hull 106 of an offshore installation 100 such as a jack-up is known and will not be discussed in further detail.

In some examples, the offshore installation hull 106 may float on the surface 108 of a body of water 110 and may be transported to a desired location. In some examples, the offshore installation 100 comprises one or more propulsors (not shown) such as an azimuthing thruster for moving the offshore installation 100 between locations. Alternatively, in some examples, the offshore installation 100 does not comprise propulsors and is towed when the offshore installation 100 is moved e.g. via tugboats. In some examples, the offshore installation 100 is towed with a towing vessel between the locations whether or not the offshore installation 100 comprises propulsors.

FIG. 1 shows the offshore installation 100 in an operational configuration where the offshore installation hull 106 has been raised above the surface 108 of the water 110. During operation of the offshore installation 100, a crane 112 can lift loads for offshore operations. In some examples, the crane 112 is configured to lift cargo 114 from a vessel 102. The offshore installation 100 comprises a deck 118 for storing the cargo 114. The crane 112 for example, may lift the cargo 114 from the vessel 102 and place the cargo 114 on the deck 118. Operation of a crane 112 on an offshore installation 100 is known and will not be discussed in any further detail.

In some examples the cargo 114 may be one or more components e.g. blades, nacelles, towers, equipment etc of a wind turbine generator (WTG). Indeed, the offshore installation 100 is positioned adjacent to a transition piece (not shown) of a WTG. The transition piece is ready to receive one or more WTG components.

In some examples, the vessel 102 as shown in FIG. 1 is a supply barge 102 which comprises propulsors (not shown) for moving the supply barge 102 under its own power. In some examples, the supply barge 102 can be towed into position with another vessel e.g. an anchor handling vessel (not shown). The term “vessel” 102 is a powered barge, an unpowered barge, or a combination of a barge and another powered vessel such as an anchor handling vessel. In other examples, any suitable vessel 102 can be used with the offshore installation 100. Hereinafter the term “vessel” 102 will be used in reference to the examples described in the accompanying Figures.

The vessel 102 comprises a vessel deck 120 for securing and transporting loads to the offshore installation 100. The cargo 114 may optionally secured to the vessel deck 120 with sea fastenings when the vessel 102 sails to the offshore installation 100. As shown in FIG. 1, cargo 114 is positioned on the vessel deck 120. As mentioned above, in some examples, the cargo 114 is one or more WTG components. In other examples, the cargo 114 can be additionally or alternatively one or more of equipment, personnel, and/or supplies for the offshore installation 100 e.g. components for an offshore oil rig. In other examples, the cargo 114 can be additionally or alternatively one or more of a transition piece, a monopile, a jacket and/or any other components of an offshore wind turbine generator or wind turbine generator farm. Optionally, the cargo 114 comprises a cargo carrying platform (not shown) and/or a frame (not shown) for securely mounting the cargo 114 thereto.

In some examples, the vessel 102 does not have cargo 114 and may approach the offshore installation 100 empty.

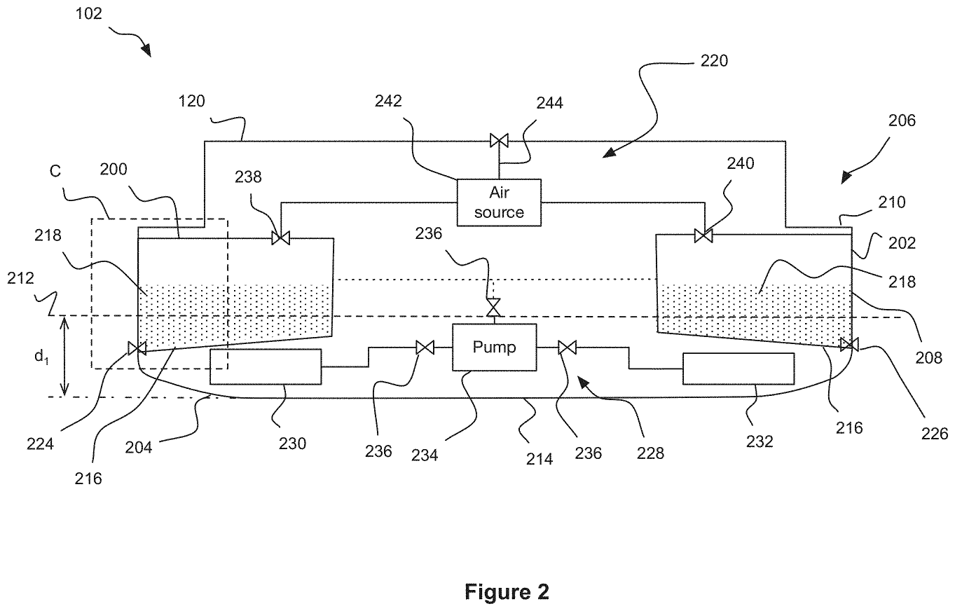

The vessel 102 will now be described in more detail with reference to FIG. 2, FIG. 2 shows a schematic cross-sectional front view of the vessel 102 in the plane of A-A (and perpendicular to the longitudinal axis of the vessel 102) as shown in FIG. 1. The vessel 102 comprises a vessel hull 204 and a vessel deck 120. The vessel hull 204 is a monohull and comprises a flat bottom 214 as shown in FIG. 2. However, the vessel hull 204 can comprise any number of hulls (e.g. dual hull, tri-hull etc). Furthermore in other examples, the vessel hull 204 can have a convex shaped bottom, or any other shaped vessel hull 204 as required.

The vessel hull 204 is arranged to float with a first draft d₁ as indicated in FIG. 2 as the distance between the waterline 212 and the flat bottom 214 of the vessel hull 204. As discussed below, the vessel hull 204 is arranged to vary the draft with a primary ballasting system 220. The primary ballasting system 220 is discussed in more detail below.

The vessel deck 120 as shown in FIG. 2 comprises a flat surface. The vessel deck 120 can comprise one or more sea fastenings for securely coupling the cargo 114. In some examples, the vessel deck 120 can comprise structural features such as a wheelhouse, bridge, accommodation, or any other component or machinery for the vessel 102. However, in other examples the vessel 102 does not comprise any structure features on the vessel deck 120. This can provide more space for receiving cargo 114.

The vessel 102 optionally comprises a shoulder portion 206 around the periphery of the vessel deck 120 or the side wall 208 of the vessel hull 204. The shoulder portion 206 comprises an engagement surface 210 which is configured to receive an external securing mechanism 304, 306 mounted on the offshore installation 100. The shoulder portion 206 and the engagement surface 210 can extend around the periphery of the vessel 102, e.g. on both sides of the vessel 102 as shown in FIG. 2. In other examples, the shoulder portion 206 and the engagement surfaces 210 are discrete and are a plurality of different locations spaced around the periphery of the vessel 102 for receiving the securing mechanism 304, 306. For example, there can be two shoulder portions 206 and engagement surfaces 210 on the port and starboard sides of the vessel 102. In other examples there can be any number of engagement surfaces 210 on the vessel 102. In some other examples there is no shoulder portion 206 on the vessel 102, In this case, one or more engagement surfaces 210 can be provided on any other part of the vessel 102, for example but not limited to the vessel deck 120.

The operation of the securing mechanism 304, 306 will be discussed in further detail below. The shoulder portion 206 provides a suitable target for the securing mechanism 304, 306 to engage with around the periphery of the vessel 102. This allows for more space on the vessel deck 120 to receive cargo 114.

However in other examples (not shown), the vessel deck 120 comprises one or more engagement surface 210 locations for receiving the securing mechanism 304, 306.

The vessel 102 comprises a primary ballasting system 220, In some examples, the primary ballasting system 220 is a passive system without a pump, this will be explained in further detail below. In some examples, the primary ballasting system 220 may be the only ballasting system 220 on the vessel 102. The primary ballasting system 220 is arranged to flood and alter the draft of the vessel 102. Operation of the primary ballasting system 220 will be discussed in further detail below. The primary ballasting system 220 comprises at least one ballasting tank and as shown in FIG. 2 comprises a first ballasting tank 200 and a second ballasting tank 202. The first and second ballasting tanks 200, 202 are arranged to hold ballast or ballast water 218. The first and second ballasting tanks 200, 202 are partially filled with ballast water 218 as shown in FIG. 2. The first and second ballasting tanks 200, 202 can be emptied or filled as required in order to adjust the draft of the vessel 102.

The term “ballasting” refers to operation of filling the first ballasting tank 200 and the second ballasting tank 202 with ballast water 218. Similarly the term “deballasting” refers to the operation of emptying the first ballasting tank 200 and the second ballasting tank 202 of ballast water 218. By ballasting and deballasting the first ballasting tank 200 and the second ballasting tank 202, the draft of the vessel 102 can be adjusted.

The ballast water 218 as shown in FIG. 2 comprises water from the immediate surroundings of the vessel 102. For example, the ballast water 218 is seawater. In some examples, the ballast water 218 is emptied in the same water ecosystem where the first and second ballasting tanks 200, 202 are filled. This means that the vessel 102 will not transport ballast water 218 from one location and contaminate another water ecosystem with the ballast water 218 e.g. by discharging ballast water 218 with invasive fauna, flora, or microorganisms.

This means that optionally, the primary ballasting system 220 does not comprise a water treatment system for the ballast water 218. This is advantageous because the process of emptying the first and second ballasting tanks 200, 202 is quicker since the ballast water 218 does not need to be treated before discharging. Treatment of the ballast water 218 in a ballast water treatment system can comprise filtration, exposing the ballast water to UV light, heating the ballast water, addition of chemical purifiers etc. A vessel 102 without a ballast water treatment system is lighter and more fuel efficient. For example, the vessel 102 does not need filters, heaters, UV treatment, or chemical treatment tanks. However, in some examples, the vessel 102 may comprise a backup ballast water treatment system (not shown) in case the vessel 102 is not able to discharge the ballast water 218 in the same water ecosystem where the first and second ballasting tanks 200, 202 were filled.

Whilst FIG. 2 only shows two ballasting tanks 200, 202, the primary ballasting system 220 in other examples can comprise any number of ballasting tanks 200, 202 as required.

The first and second ballasting tanks 200, 202 are positioned on each side of the vessel 102. The first and second ballasting tanks 200, 202 in some examples can extend along the entire length of the vessel 102 along the longitudinal axis B-B as shown in FIG. 1. In other examples, there can be additional ballasting tanks position along the length of the longitudinal axis B-B. In an alternative example, there is a single ballasting tank (not shown) which extends across the width of the vessel hull 204 as shown in FIG. 2. The primary ballasting system 220 can comprise any number of ballasting tanks 200, 202 with any shape or form in dependence of the size and shape of the vessel 102.

In some examples, the first and second ballasting tanks 200, 202 each comprise a downwardly sloping bottom surface 216. Each of the first and second ballasting tanks 200, 202 respectively comprise at least one port 222, 224. The ports 222, 224 are in fluid communication with the first and second ballasting tanks 200, 202. The ports 222, 224 arranged to selectively adjust the flow of ballast water 218 in and out of the first and second ballasting tanks 200, 202 to the surrounding body of water 110.

FIG. 2 shows the first and second ballasting tanks 200, 202 only comprising a single port 222, 224. However in other examples, there can be further ports (not shown) in each of the first and second ballasting tanks 200, 202, For example there can be six ports 222, 224 along the length of the first and second ballasting tanks 200, 202 for filling and emptying the first and second ballasting tanks 200, 202 with ballast water 218. There can be any suitable number of ports 222, 224 as required to adjust the flow of the ballast water 218 in and out of the first and second ballasting tanks 200, 202.

The ports 222, 224 can be remotely operated by a user or remotely actuated by an autonomous system e.g. a controller (not shown). The ports 222, 224 in some examples are a hydraulically actuated valves. In other examples, the ports 222, 224 can be any suitable mechanism for opening and closing an outlet/inlet on the first and second ballasting tanks 200, 202.

Since the downwardly sloping bottom 216 directs the ballasting water 218 to the ports 222, 224, the ballast water 218 will empty out of the first and second ballasting tanks 200, 202 under the force of gravity. Additionally, the ballast water 218 may empty out of the first and second ballasting tanks 200, 202 due to the hydrostatic pressure of the ballast water 218 in the first and second ballasting tanks 200, 202.

Accordingly, the emptying and filling of the first and second ballasting tanks 200, 202 on the vessel 102 can be achieved passively, That is, the first and second ballasting tanks 200, 202 can be emptied without the need of a pump. Optionally however, the primary ballasting system 220 may comprise at least one pump 234 for emptying ballast water 218 from the first and second ballasting tanks 200, 202. The pump 234 in some examples can be used for emptying any remaining ballast water 218 at the bottom of the first and second ballasting tanks 200, 202.

Optionally, the first and second ballasting tanks 200, 202 on the vessel 102 comprises a first and second air valves 238, 240 in fluid communication with an air source 242 external to the first and second ballasting tanks 200, 202. The external air source 242 can be an air duct 244 connected to the external atmosphere. Alternatively, the external air source can be a source of compressed air and/or a vacuum pump. In this way, as the ballast water 218 is emptied from the first and second ballasting tanks 200, 202, the first and second air valves 238, 240 can be opened to equalise the pressure in the first and second ballasting tanks 200, 202 with the atmospheric pressure. This removes the vacuum generated by the ballast water 218 in the first and second ballasting tanks 200, 202 due to emptying from the first and second ballasting tanks 200, 202 in the deballasting operation.

Likewise, the first and second air valve 238, 240 can be opened during the ballasting operation to allow compressed air to escape when the first and second ballasting tanks 200, 202 are filled with ballast water 218. Similar to the source of compressed air, the vacuum pump can be used to equalised the compressed air in the first and second ballasting tanks 200, 202 with the atmospheric pressure. The first and second air valves 238, 240 and the air source 242 are not necessary, but advantageously allow for completely emptying and filling of the first and second ballasting tanks 200, 202 in the absence of the pump 234.

In some examples, the pump 234 can be dual purpose and be used for the primary ballasting system 220 and another optional secondary closed ballasting system 228.

In some examples and as shown in FIG. 2, the vessel 102 optionally comprises a secondary closed ballasting system 228. The secondary closed ballasting system 228 is arranged to move secondary ballast water (not shown) between first and second secondary ballasting tanks 230, 232 with the pump 234. In some examples, there can be further secondary ballasting tanks (not shown) so that there are secondary ballasting tanks 230, 232 on port, starboard, aft and bow sides of the vessel 102. In this way the secondary ballast water can be moved between the secondary ballasting tanks to adjust the heel and trim of the vessel 102. The secondary closed ballasting system 228 can be periodically adjusted to tailor the operation of the vessel 102 in dependence on the type of cargo 114 e.g. for different types of wind turbine generator.

The secondary closed ballasting system 228 is closed and therefore none of the secondary ballast water is discharged from the vessel 102 under normal operation.

One or more valves 236 may be provided to shut the secondary ballast water and the secondary closed ballasting system 228 off from the first and second ballasting tanks 200, 202. In this way, the pump 234 can selectively be used with either the primary ballasting system 220 or the secondary closed ballasting system 228.

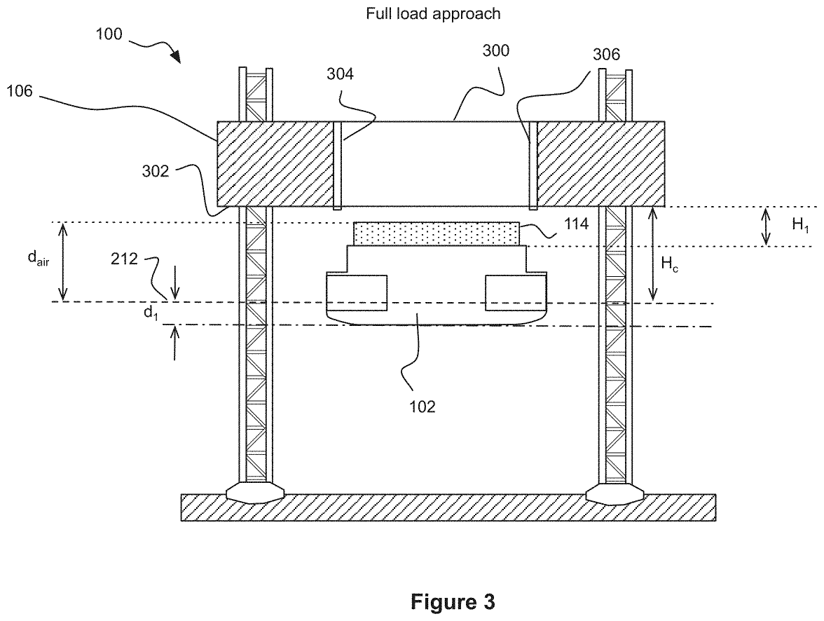

Operation of the primary ballasting system 220 will now be discussed in reference to FIGS. 3 to 11. FIGS. 3 to 11 show a front view of the offshore installation 100 and the vessel 102 at different stages of a ballasting and deballasting method of the vessel 102 according to an example.

The vessel 102 as shown in FIGS. 3 to 11 is positioned at least partially underneath the offshore installation hull 106. In some examples, the vessel 102 is fully underneath the offshore installation hull 106. Alternatively, only a portion of the vessel 102 projects underneath the offshore installation hull 106. In other examples, the vessel 102 can be positioned adjacent to the side of the offshore installation 100 and not underneath the offshore installation hull 106.

At least a portion of the vessel 102 is moved underneath the offshore installation hull 106 when the offshore installation hull 106 is positioned out of the water 110 and the legs 104a, 104b engage the seafloor 116. In this way, there is a clearance H_{c} between the underside 302 of the offshore installation hull 106 and the waterline 212.

The offshore installation hull 106 may optionally comprise at least one guide structure (not shown) such as a fender for laterally positioning the vessel 102 underneath the offshore installation hull 106 or within a cut-out 300 of the offshore installation hull 106. In some examples, there is a first lateral guide structure and a second lateral guide structure for limiting the lateral movement either side of the vessel 102.

The cut-out 300 provides access to the vessel deck 120 of the vessel 102 from above when at least a portion of the vessel 102 is underneath the offshore installation hull 106. This means that the cargo 114 can be lifted vertically off the vessel deck 120. In the example shown in e.g. FIG. 3 the cut-out 300 is in the periphery of the offshore installation hull 106. This means that the offshore installation 100 may have a “U” shaped offshore installation hull 106. In another example, the cut-out 300 may be located in the centre of the deck 118 of the offshore installation 100. This means that the offshore installation 100 comprises a hole or a moonpool (not shown) for receiving the cargo 114 therethrough.

The offshore installation 100 comprises a first securing mechanism 304 and a second securing mechanism 306 arranged to engage the vessel 102 and prevent or limit movement of the vessel 102 with respect to the offshore installation 100 when engaged.

In some examples, the first and second securing mechanisms 304, 306 comprise first and second moveable arms arranged to move vertically down to the vessel 102. The first and second moveable arms are coupled to hydraulically actuated pistons (not shown) to move the first and second moveable arms. Alternatively the first and second moveable arms are coupled to a rack and pinion mechanism arranged to move the first and second moveable arms. In some other examples, any other suitable mechanism can be used to selectively control movement of the first and second moveable arms. For example, the mechanism can be actuated with pneumatic pistons, mechanical linkages, chain drives etc.

FIGS. 3 to 11 only show the first and second securing mechanisms 304, 306 however there may be more securing mechanisms to further secure the vessel 102. For example there can be four or six securing mechanisms spaced apart configured to engage the vessel 102 at different positions along the longitudinal axis A-A of the vessel 102.

The first and second securing mechanisms 304, 306 are engageable with the vessel deck 120 or the shoulder portion 206 of the vessel 102 positioned underneath the offshore installation hull 102 or within the cut-out 300. The first and second securing mechanisms 304, 306 push down on the vessel deck 120 or the shoulder portion 206 and this reduces the relative movement of the vessel 102 with respect to the offshore installation 100. When the first and second securing mechanisms 304, 306 push down on vessel 102, the buoyant force acting on the vessel 102 increases. This results in the vessel 102 being engaged with the offshore installation 100 and stops or limits the relative movement therebetween. In other words, the waves and current of the surrounding water 110 acting on the vessel 102 do not cause the vessel 102 to move relative to the offshore installation 100 when first and second securing mechanisms 304, 306 engage vessel 102.

The first and second securing mechanisms 304, 306 as shown in FIG. 3 are in a raised position and are not in engagement with the vessel 102.

The vessel 102 as shown in FIG. 3 is fully laden with cargo 114. For the purposes of clarity, the cargo 114 is shown as a rectangle, but can be any shape or size. As the vessel 102 approaches the offshore installation 100, the vessel 102 has a first draft d₁.

Furthermore the height of the vessel 102 and cargo 114 above waterline 212 has an air draft of dₐᵢᵣ. Although the cargo 114 is shown underneath the offshore installation hull 106 in FIG. 2, the cargo 114 in some examples may project through the cut-out 300.

As can be seen from FIG. 3, the offshore installation hull 106 is lifted out of the water 110 and provides a total clearance H_{c} underneath the offshore installation 100. The draft of the vessel 102 is adjusted in order to move underneath the offshore installation 100. The vessel deck 120 in FIG. 3 is at a first deck clearance H₁ from the underside 302 of the offshore installation hull 106. The first deck clearance H₁ is such that the vessel deck 120 or the cargo 114 do not collide with the underside 302 of the offshore installation hull 106. Accordingly, the vessel 102 is able to be maneuvered underneath the offshore installation 100 without clashing with the underside 302 of the offshore installation hull 106.

In order to accommodate the sea conditions, the first deck clearance H₁ may comprise an additional safety margin in order to take into account the heave experienced by the vessel 102.

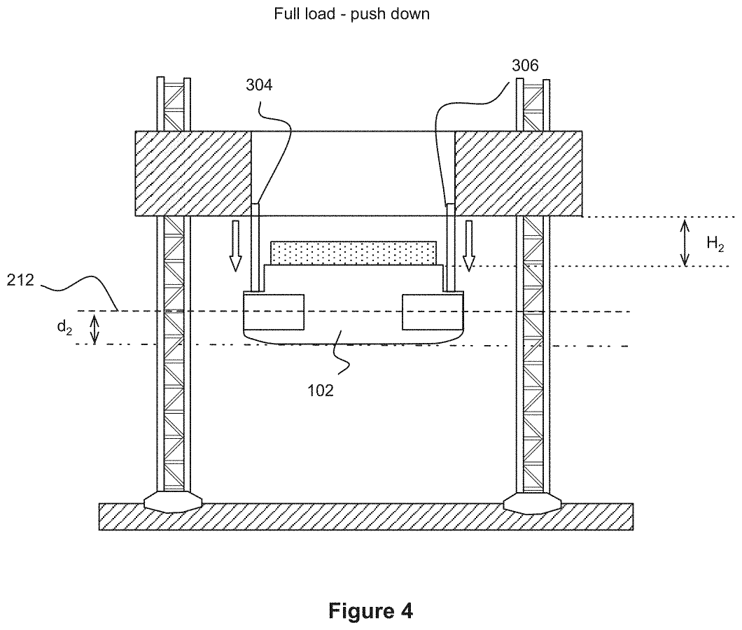

FIG. 4 shows the first and second securing mechanisms 304, 306 engaging with the vessel 102. In this case the first and second securing mechanisms 304, 306 push down on the vessel 102. The vessel 102 is now fixed with respect to the offshore installation 100. The first and second securing mechanisms 304, 306 push the vessel 102 down and increases the draft of the vessel 102 from the first draft d₁ to a second draft d₂.

Since the vessel 102 has been pushed down, the vessel deck 120 is now positioned at a second deck clearance H₂. The second deck clearance H₂ is greater than the first deck clearance H₁.

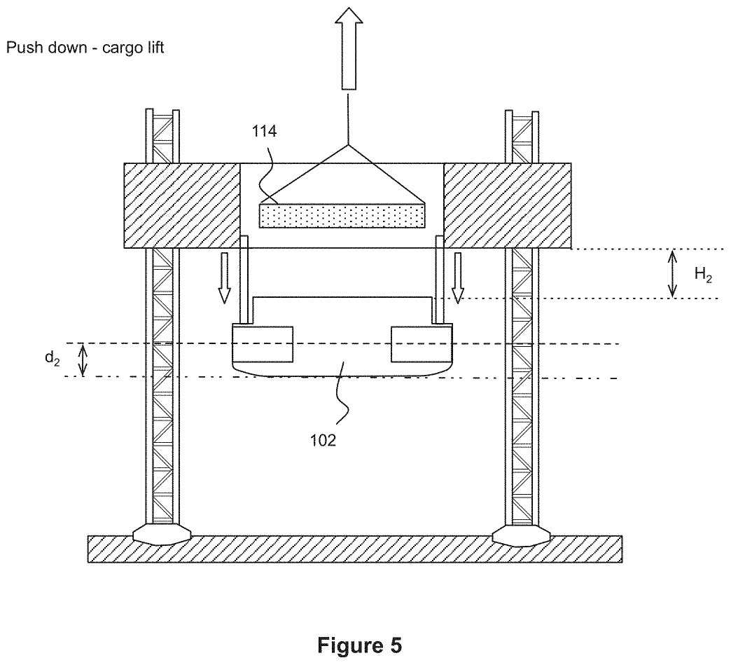

FIG. 5 shows the cargo 114 being lifted off the vessel deck 120. The cargo 114 can be hoisted up by the crane 112, however other lifting mechanisms can be used. For example the lifting mechanism comprising a plurality of arms as described in WO2020/200379 and incorporated by reference herein can be used. Indeed any suitable mechanism for lifting the cargo 114 can be used.

Since the first and second securing mechanisms 304, 306 are still in engagement with the vessel 102, the vessel 102 is still at the second draft d₂ and the vessel deck 120 is still positioned at a second deck clearance H₂. However, since the cargo 114 has been lifted off the vessel deck 120, the upwards force exerted by the vessel 102 is increased on the first and second securing mechanisms 304, 306. The first and second securing mechanisms 304, 306 optionally comprise one or more locking mechanisms (not shown) for fixing the first and second securing mechanisms 304, 306 in place when the cargo 114 is lifted off the vessel 102. In some examples, the locking mechanism can be a ratchet, a locking pin, or any other suitable mechanism for maintaining the first and second securing mechanisms 304, 306 in the engaged position as shown in FIG. 5.

In some scenarios, if the first and second securing mechanisms 304, 306 were to be released once the cargo 114 has been lifted off the vessel 102, the vessel 102 would raise to a draft smaller than the first draft d₁. This would mean that the vessel deck 120 would be positioned beneath the underside 302 of the offshore installation hull 106 with a zero clearance or a very small clearance. Accordingly, the vessel deck 120 would immediately collide with the underside 302 or collide with the underside 302 as soon as a large enough wave raised the vessel 102.

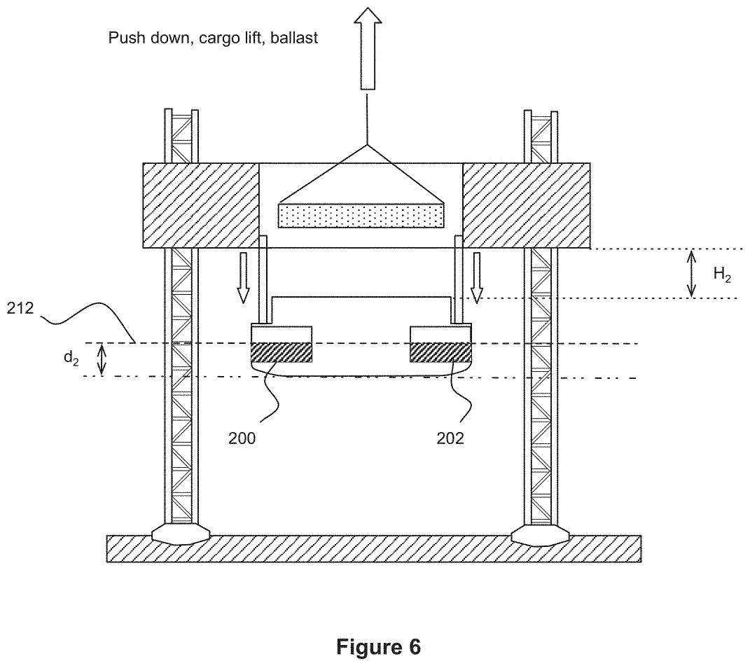

FIG. 6 shows how this problem is mitigated. Whilst the first and second securing mechanisms 304, 306 are still engaged with the vessel 102, the first and second ballasting tanks 200, 202 are at least partially filled. The first and second ballasting tanks 200, 202 are opened and the ballast water 218 e.g. the seawater surrounding the vessel 102 fills the first and second ballasting tanks 200, 202 until the ballast water 218 is at the same level as the waterline 212. Alternatively, the ballast water 218 fills the first and second ballasting tanks 200, 202 until the ports 222, 224 are closed.

In some examples, the first and second ballasting tanks 200, 202 are filled with ballast water 218 having the same weight as the cargo 114. This means that the vessel 102 will have a similar draft as when the vessel 102 was loaded with the cargo 114 as shown in FIG. 3.

In some examples, the first and second ballasting tanks 200, 202 are filled with ballast water 218 having a weight less than that of the cargo 114. Alternatively, in some examples the first and second ballasting tanks 200, 202 are filled with ballast water 218 having a weight equal to or greater than that of the cargo 114. This means that the vessel 102 will have a smaller draft than when the vessel 102 was loaded with the cargo 114 as shown in FIG. 3. This may be advantageous because the weight of the ballast water 218 required to fill the first and second ballasting tanks 200, 202 may only need to be only a proportion of the weight of the cargo 114. For example, it may be acceptable to allow the vessel 102 to have a smaller draft than the first draft d₁ when the vessel 102 was loaded with the cargo 114 because there is still sufficient clearance under the offshore installation 100 when the vessel 102 has a ballast water 218 with a weight equivalent to a proportion of the cargo 114.

In some examples, the ratio of the weight of the ballast water 218 to the weight of the cargo 114 is 46%. In some other examples the ratio of the weight of the ballast water 218 to the weight of the cargo 114 is 40% to 50%, 30% to 60%. In some examples, the ratio of the weight of the ballast water 218 to the weight of the cargo 114 is 100%. In some examples the weight of the cargo 114 is 5400 tonnes and the weight of the ballast water 218 is 2500 tonnes.

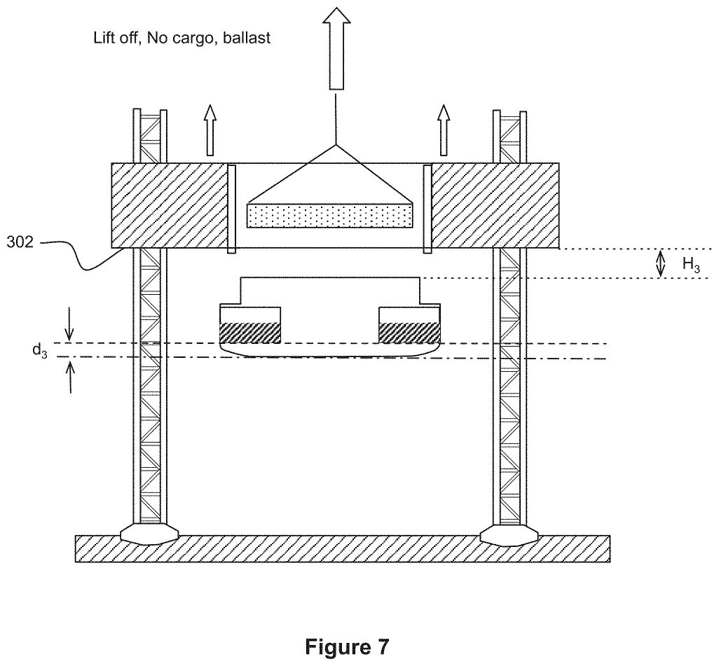

In some examples, the first and second securing mechanisms 304, 306 are released from the vessel 102 after the first and second ballasting tanks 200, 202 have been ballasted as shown in FIG. 7. Since the vessel 102 is no longer being pushed down from by the first and second securing mechanisms 304, 306, the vessel 102 rises in the water 110 from the second draft d₂ to a smaller third draft d₃. In the case where the first and second ballasting tanks 200, 202 are filled with a weight of ballast water 218 equal to the cargo 114, the third draft d₃ will equal the first draft d₁.

In the case where the first and second ballasting tanks 200, 202 are filled with a % weight of ballast water 218 compared to the cargo 114 (e.g. 45% of the weight of the cargo 114), the third draft d₃ will smaller than the first draft d₁.

The vessel deck 120 is positioned at a third deck clearance H₃ which is smaller than the second deck clearance H₂. In other words, the vessel 102 floats higher in the water 110 and the vessel deck 120 is closer to the underside 302 of the offshore installation 100. The third deck clearance H₃ is sufficiently large to include a safety margin to account for the heave conditions of the sea such that the vessel 102 does not collide with the underside 302 of the offshore installation 100.

The vessel 102 is therefore able to freely move out from the offshore installation 100 since the first and second securing mechanisms 304, 306 are no longer engaged with the vessel 102.

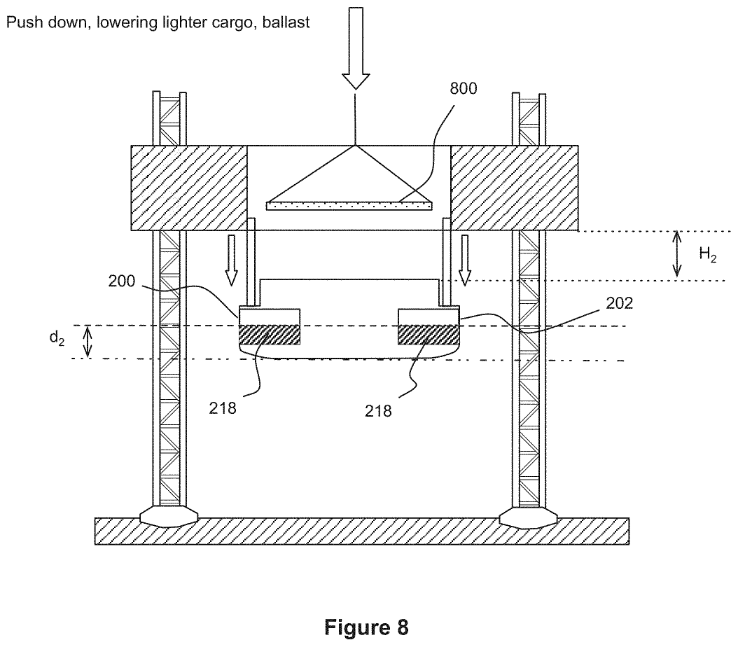

Alternatively, instead of releasing the vessel 102 as shown in FIG. 7, the vessel 102 can be loaded with additional cargo 800 as shown in FIG. 8 via the crane 112. This operation could also be performed after a second docking with the offshore installation 100. In this case the vessel 102 can undock from the offshore installation 100 and wait at a distance from the offshore installation 100 before redocking and loading with additional cargo 800. This may be advantageous because the vessel 102 can wait at a distance from the offshore installation 100 until the crane 112 is ready to perform a loading operation. By keeping the vessel 102 at a distance from the offshore installation whilst waiting, the vessel 102 reduces the risk of being docked to the offshore installation 100 in heavy seas e.g. if the weather changes. This means that the vessel 102 can undock from the offshore installation 100 without being empty improving logistical efficiency. As shown in FIG. 8, the first and second securing mechanisms 304, 306 still engage the vessel 102 and the vessel 102 is still at the second draft d₂ and the vessel deck 120 is still positioned at a second deck clearance H₂.

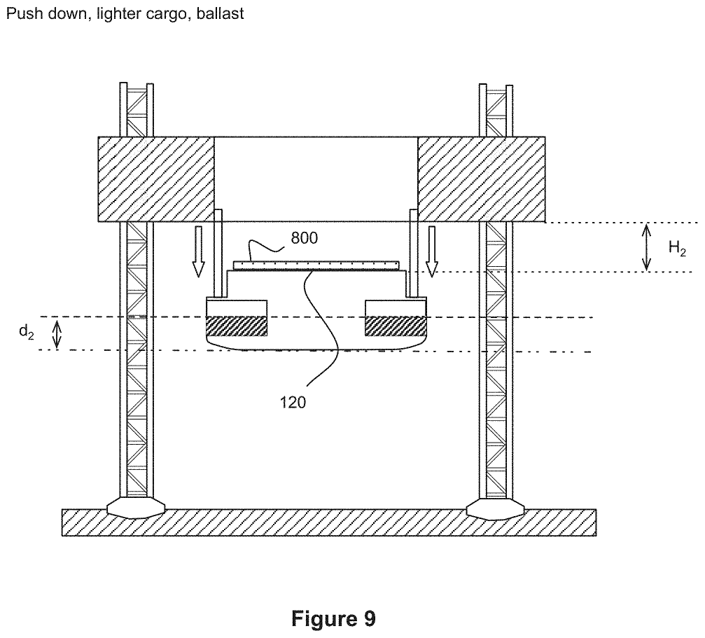

In some examples, the additional cargo 800 is lighter than the cargo 114 as shown in FIG. 3. The additional cargo 800 can be an empty frame (not shown) or a pallet (not shown) for transporting WTG components. In some examples, the additional cargo 800 is approximately 50% the weight of the cargo 114. FIG. 9 shows the additional cargo 800 having been placed on the vessel deck 120.

In this case, the additional cargo 800 and the ballast water 218 are approximately the same weight as the cargo 114. Alternatively the ballast water 218 can be substantially the same weight as the cargo 114. When the vessel 102 is reloaded with the additional cargo 800, less ballast water 218 may be needed in the first and second ballasting tanks 200, 202 than if the vessel 102 undocks empty with no cargo. This is advantageous because the time to ballast the first and second ballasting tanks 200, 202 will be less. Accordingly, the undocking procedure for the vessel 102 will be less time consuming.

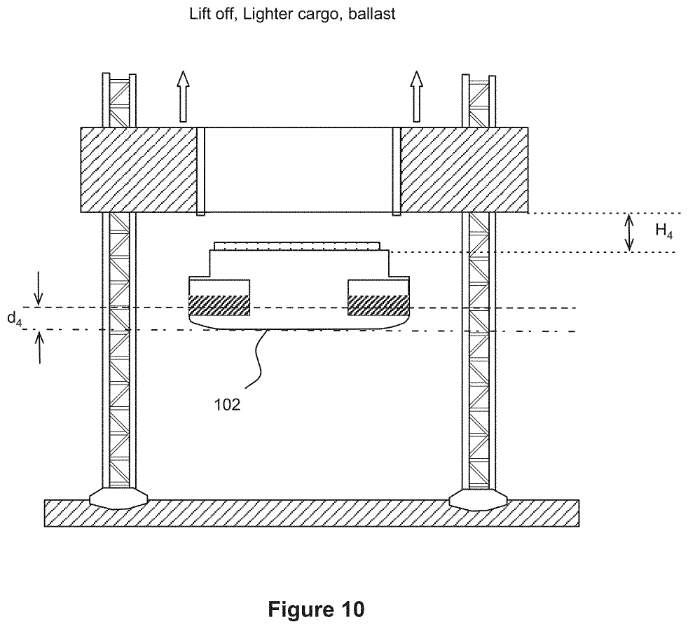

Once the additional cargo 800 has been loaded on the vessel 102, the first and second securing mechanisms 304, 306 are released from the vessel 102 as shown in FIG. 10. Again, since the vessel 102 is no longer being pushed down from by the first and second securing mechanisms 304, 306, the vessel 102 rises in the water 110 from the second draft d₂ to a smaller fourth draft d₄. In the case where the first and second ballasting tanks 200, 202 are filled with a weight of ballast water 218 equal to the cargo 114, the fourth draft d₄ will equal the first draft d₁.

In some examples, the fourth draft d₄ as shown in FIG. 10 is greater than the third draft d₃ as shown in FIG. 7. This is because the vessel 102 in FIG. 10 is loaded with the additional cargo 800 but the vessel 102 is empty in FIG. 7. The fourth draft is smaller than the first draft d₁ as shown in FIG. 3. This is because the vessel 102 is fully loaded with the cargo 114 in FIG. 3, but loaded with a smaller, lighter additional cargo 800 in FIG. 10.

In the case where the weight of the additional cargo 800 combined with the weight of ballast water 218 is a proportion of the weight of the initial cargo 114 (e.g. 45% of the weight of the cargo 114), the fourth draft d₄ will smaller than the first draft d₁, In the case where the weight of the additional cargo 800 combined with the weight of ballast water 218 is the same as the weight of the initial cargo 114, the fourth draft d₄ will approximately be the same as the first draft d₁.

The vessel deck 120 is positioned at a fourth deck clearance H₄ which is smaller than the second deck clearance H₂. In other words, the vessel 102 floats higher in the water 110 and the vessel deck 120 is closer to the underside 302 of the offshore installation 100. The fourth deck clearance H₄ is sufficiently large to include a safety margin to account for the heave conditions of the sea such that the vessel 102 does not collide with the underside 302 of the offshore installation 100.

The vessel 102 is therefore able to freely move out from the offshore installation 100 since the first and second securing mechanisms 304, 306 are no longer engaged with the vessel 102.

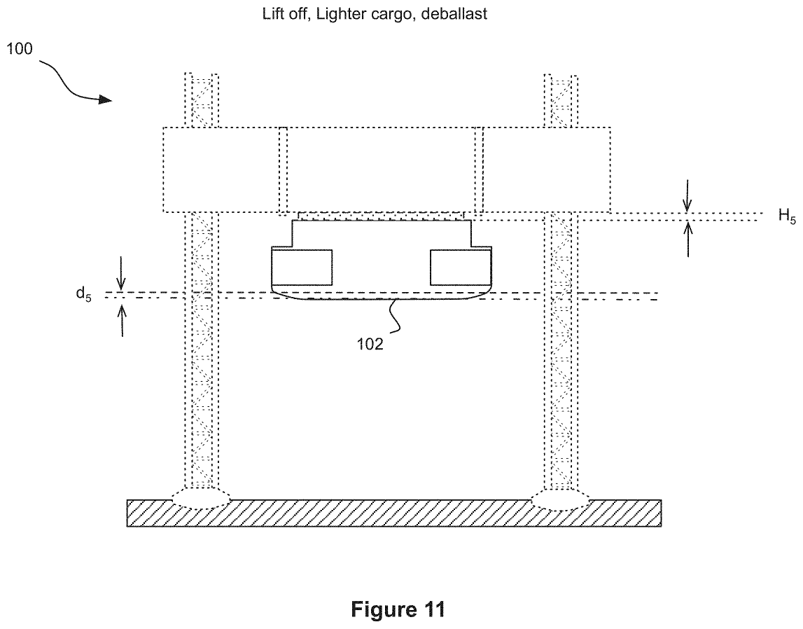

Once the vessel 102 is clear of the offshore installation 100, the vessel 102 can deballast and empty the first and second ballasting tanks 200, 202. FIG. 11 shows the vessel 102 with empty first and second ballasting tanks 200, 202. The offshore installation 100 is shown in a dotted outlined to indicate how high the vessel 102 floats in the water 110 compared to the offshore installation 100. However, the vessel 102 once deballasted will not be near the offshore installation 100.

As can be seen in FIG. 11, the vessel 102 has a fifth draft d₅ which is smaller than the vessel draft shown in any of the preceding Figures. Similarly the vessel deck 120 is positioned at a fifth deck clearance H₅ which is smaller than any of the preceding Figures. Indeed, as shown in FIG. 11, there is a zero or possibly a negative clearance between the vessel deck 120 and the underside 302 of the offshore installation 100. This means that the vessel 102 in some examples may not deballast underneath the offshore installation 100. Accordingly, the air draft of the vessel 102 and a predetermined heave of the waves (e.g. 1 m to 2.5 m) and a safety margin are greater than the clearance H_{c} between the underside 302 of the offshore installation hull 106 and the waterline 212. This means that the vessel 102 may need to deballast after undocking from the offshore installation 100, especially when the vessel 102 undocks from the offshore installation 100 empty.

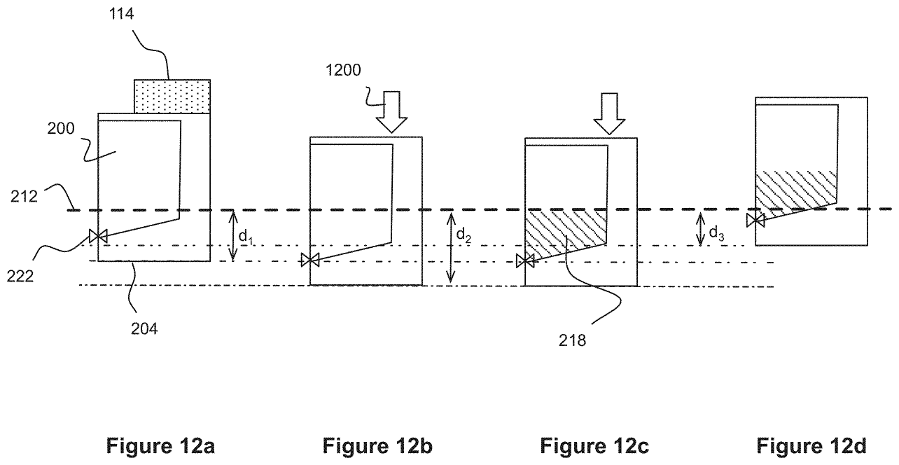

Turning to FIGS. 12a, 12b, 12c, 12d, 13a, 13b, 13c, 14 and 15, the process of the ballasting system 220 passively ballasting and deballasting the first and second ballasting tanks 200, 202 will now be discussed in further detail.

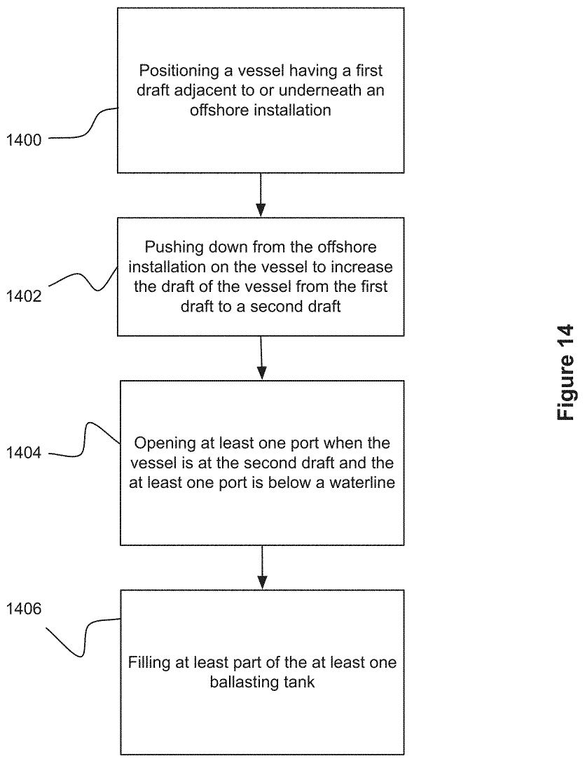

FIGS. 12a, 12b, 12c, and 12d show a close up of the vessel 102 at different stages of ballasting the first ballasting tank 200 as represented in the dotted box C in FIG. 2. FIG. 14 shows a flow diagram of the method of ballasting the vessel 102.

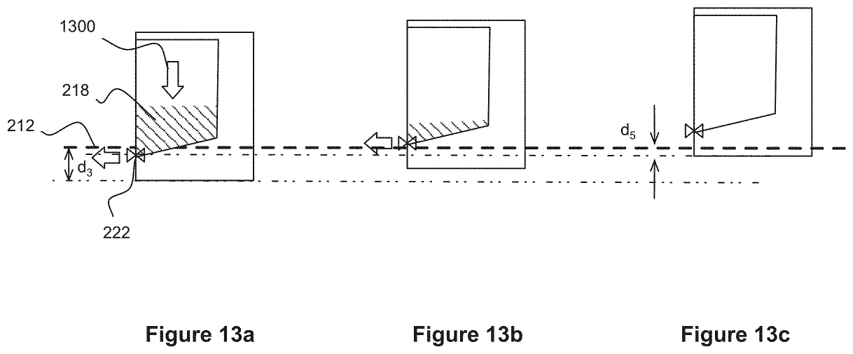

Whilst only the first ballasting tank 200 is shown in FIGS. 12a, 12b, 12c, 12d, 13a, 13b, 13c, the same principles apply to the second ballasting tank 202 or any other ballasting tanks in the primary ballasting system 220.

FIG. 12a shows the vessel 102 fully loaded with the cargo 114. In this arrangement the vessel hull 204 of the vessel 102 has a first draft d₁. A portion of the first ballasting tank 200 is below the waterline 212 including the port 222. The vessel 102 is positioned underneath or adjacent to the offshore installation 100 as shown in step 1400 of FIG. 14. In some examples (not shown in FIG. 12a), the port 222 can be above the waterline 212 when the vessel 102 is positioned underneath the offshore installation 100.

The first and second securing mechanisms 304, 306 exert a downward force on the vessel 102 and push down from the offshore installation 100 on the vessel 102 to increase the draft of the vessel 102 from the first draft d₁ to the second draft d₂ as shown in step 1402 of FIG. 14. The downward force is shown as arrow 1200 in FIG. 12b and the vessel 102 is shown at a second draft d₂.

The port 222 is then opened when the vessel 102 is at the second draft d₂ and the port 222 is below the waterline 212 as shown in step 1404 of FIG. 14.

Since the port 222 is below the waterline 212, at least part of the first ballasting tank 200 fills with ballast water 218 e.g. seawater as shown in step 1406 of FIG. 14. Since the offshore installation 100 pushes down on the vessel 102, the first and second ballasting tanks 200, 202 can be passively ballasted without using a pump.

In some examples, the first and second air valves 238, 240 are opened. In this case, compresses air generated in the first and second ballasting tanks 200, 202 due to the ballast water 218 filling out of the first and second ballasting tanks 200, 202 is removed. This aids the ballast water 218 freely filling the first and second ballasting tanks 200, 202. In some examples, the first and second air valves 238, 240 allow the air to escape to outside the vessel 102 from the first and second ballasting tanks 200, 202. In some other examples, the first and second air valves 238, 240 remove air with a vacuum pump from the first and second ballasting tanks 200, 202.

In some examples, the weight of the ballast water 218 is between 1000 T to 5000 T. In some examples, the weight of the ballast water 218 is between 1500 T to 3500 T. In some examples, the weight of the ballast water 218 is between 1750 T to 3000 T. In some examples, the weight of the ballast water 218 is between 2000 T to 2500 T. In some examples, the weight of the ballast water 218 is 2400 T. In some examples the ballast water 218 is filled at flow rate of the ballast water 218 of between 0.25 m³ is to 3 m³/s. In some examples the ballast water 218 is filled at flow rate of the ballast water 218 of between 0.35 m³ is to 2.77 m³/s. In some examples the ballast water 218 is filled at flow rate of the ballast water 218 of between 1 m³/s to 2 m³/s. In some examples, the flow rate is between 1.3 to 1.5 m³/s. In some examples, the flow rate is 1.39 m³/s. In some examples, the time for the ballast water 218 to fill the at least one ballasting tank 200, 202 is between 900 to 7200 seconds.

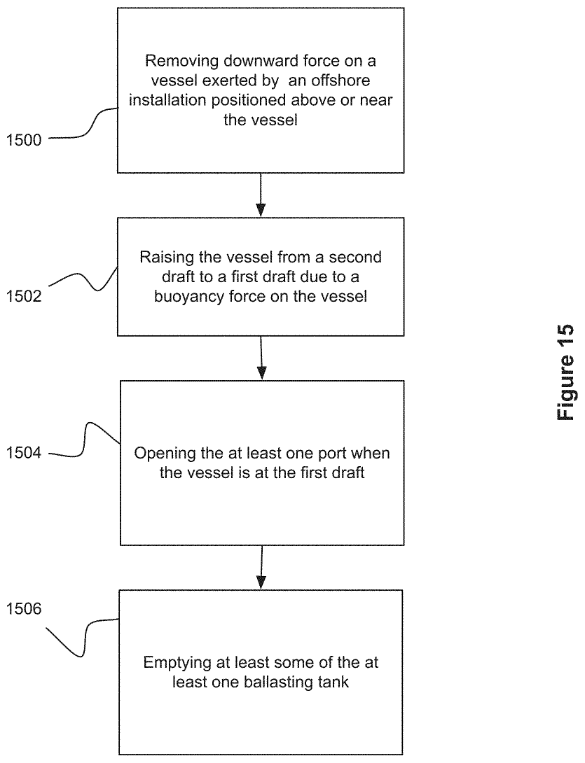

When the downward force is removed and the first and second securing mechanisms 304, 306 disengage from the vessel 102 as shown in step 1500 of FIG. 15, the vessel 102 rises and has a third draft d₃ as discussed above as shown in step 1502 of FIG. 15. As shown in FIG. 12d, part of the first ballasting tank 200 is positioned below the waterline 212 including the port 222, In some other examples, when the vessel 102 has the third draft d₃, all of the first ballasting tank 200 and the port 222 are above the waterline 212. The vessel 102 as shown in FIG. 12d represents the vessel 102 as shown in FIG. 7 or FIG. 10.

FIGS. 13a, 13b, and 13c, show a close up of the vessel 102 at different stages of deballasting the first ballasting tank 200 as represented in the dotted box C in FIG. 2. FIG. 15 shows a flow diagram of the method of deballasting the vessel 102.

FIG. 13a shows the vessel 102 having the third draft d₃ which is the same as shown in FIG. 12d. Similarly, the vessel 102 as shown in FIG. 13a represents the vessel 102 as shown in FIG. 7 or FIG. 10.

The port 222 is opened when the vessel 102 is at the third draft d₃ as shown in step 1504 of FIG. 15. The ballast water 218 empties from the first ballasting tank 200 as shown in step 1506. The ballast water 218 deballasts from the first ballasting tank 200 even though the port 222 is below the waterline 212 due to the hydrostatic pressure 1300 of the ballast water 218 in the first ballasting tank 200. This is because the first ballasting tank 200 comprises a column of ballast water 218 with at least a portion of the column above the waterline 212.

In some examples, the first and second air valves 238, 240 are opened. In this case, a vacuum generated in the first and second ballasting tanks 200, 202 due to the ballast water 218 emptying out of the first and second ballasting tanks 200, 202 is removed. This aids the ballast water 218 freely draining from the first and second ballasting tanks 200, 202. In some examples, the first and second air valves 238, 240 introduce air from outside the vessel 102 into the first and second ballasting tanks 200, 202. In some other examples, the first and second air valves 238, 240 introduce air from an onboard supply of compressed air 244 into the first and second ballasting tanks 200, 202.

As the ballast water 218 deballasts, the vessel 102 rises and the draft decreases until the port 222 is above the waterline 212 as shown in FIG. 13b. At this point, the ballast water 218 empties from the first ballasting tank 200 due to gravity.

In some examples, the weight of the ballast water 218 is between 1000 T to 5000 T. In some examples, the weight of the ballast water 218 is between 1500 T to 3500 T. In some examples, the weight of the ballast water 218 is between 1750 T to 3000 T. In some examples, the weight of the ballast water 218 is between 2000 T to 2500 T. In some examples, the weight of the ballast water 218 is 2400 T. In some examples the ballast water 218 is filled at flow rate of the ballast water 218 of between 0.25 m³/s to 3 m³/s. In some examples the ballast water 218 is filled at flow rate of the ballast water 218 of between 0.35 m³/s to 2.77 m³/s. In some examples the ballast water 218 is emptied at flow rate of the ballast water 218 of between 1 m³/s to 2 m³/s. In some examples, the flow rate is between 1.3 to 1.5 m³/s. In some examples, the flow rate is 1.39 m³/s. In some examples, the time for the ballast water 218 to empty the at least one ballasting tank 200, 202 is between 900 to 7200 seconds. In some examples, the ballast water 218 is emptied from the first and second ballasting tanks 200, 202 in a duration of 1500 s to 2500 s. In some examples the duration is 1800 s.

When the first ballasting tank 200 is empty as shown in FIG. 13c, the vessel 102 is at the fifth draft d₅ as shown in FIG. 11.

Similar to the passive ballasting, the first and second ballasting tanks 200, 202 can be passively deballasted. This means that the first and second ballasting tanks 200, 202 can use the difference in the draft of the vessel 102 when the first and second securing mechanisms 304, 306 push down on the vessel 102 and when the first and second securing mechanisms 304, 306 disengage from the vessel 102. Accordingly, the ballast water 218 can empty out of the first and second ballasting tanks 200, 202 under the force of gravity and/or hydrostatic pressure without the need for a pump.

Advantageously this means that the vessel 102 can be quickly ballasted and deballasted without a pump and without a ballast water treatment system.

In another example, two or more examples are combined. Features of one example can be combined with features of other examples.

Examples of the present disclosure have been discussed with particular reference to the examples illustrated. However, it will be appreciated that variations and modifications may be made to the examples described within the scope of the disclosure.

1. A method of ballasting a vessel comprising:
positioning a vessel having a first draft adjacent to or underneath an offshore installation, the vessel having at least one ballasting tank and at least one port in fluid communication with the at least one ballasting tank arranged to selectively adjust a flow of ballast water in and out of the at least one ballasting tank;
pushing down from the offshore installation on the vessel to increase a draft of the vessel from the first draft to a second draft;
opening the at least one port when the vessel is at the second draft and the at least one port is below a waterline; and
filling at least part of the at least one ballasting tank.

2. The method according to claim 1, wherein the at least one port is above the waterline when the vessel is at the first draft.

3. The method according to claim 1, wherein the method comprises lifting off a first cargo from the vessel after the pushing down.

4. The method according to claim 3, wherein the method comprises placing a second cargo on the vessel after the filling.

5. The method according to claim 4, wherein the second cargo is lighter than the first cargo.

6. The method according to claim 5, wherein the filling comprises filling the at least one ballasting tank until a weight of the second cargo and the at least one ballasting is the same as the weight of the first cargo.

7. The method according to claim 1, wherein the filling comprises removing air from the at least one ballasting tank.

8. A method of deballasting a vessel having at least one ballasting tank and at least one port in fluid communication with the at least one ballasting tank arranged to selectively adjust a flow of ballast water in and out of the at least one ballasting tank, the method comprising:
removing downward force on the vessel exerted by an offshore installation positioned above or near the vessel;
raising the vessel from a first draft to a second draft due to a buoyancy force on the vessel;
opening the at least one port when the vessel is at the second draft; and
emptying at least some of the at least one ballasting tank.

9. The method according to claim 8, wherein the opening the at least one port comprises opening the at least one port when the at least one port is below a waterline.

10. The method according to claim 8, wherein the emptying at least some of the at least one ballasting tank is in part in dependence of hydrostatic pressure of the ballast water in the at least one ballasting tank.

11. The method according to claim 8, wherein the emptying comprises suppling air into the at least one ballasting tank.

12. The method according to claim 8, wherein the method comprises raising the vessel to a third draft, which is smaller than the second draft wherein the at least one port is above a waterline when the vessel is at the third draft.

13. The method according to claim 12, wherein when the vessel is at the third draft, an air draft of the vessel and a predetermined heave and a safety margin is greater than a clearance between the waterline and an underside of the offshore installation.

14. The method according to claim 8, wherein the emptying comprises flow rate of the ballast water of between 0.25 m³/s to 3 m³/s.

15. The method according to claim 8, wherein the duration of the emptying is between 900 s to 7200 s.

16. The method according to claim 8, wherein the method comprises pumping ballast water out of the at least one ballasting tank.

17. A system for ballasting a vessel having a first draft comprising:
an offshore installation having
a securing mechanism arranged to push down on the vessel and increase the draft of a vessel from the first draft to a second draft; and
a vessel having
at least one ballasting tank, and
at least one port in fluid communication with the at least one ballasting tank arranged to selectively adjust a flow of ballast water in and out of the at least one ballasting tank;
wherein the at least one port is arranged to be below a waterline when the vessel is at the second draft and arranged to fill at least part of the at least one ballasting tank.

18. A system for deballasting a vessel having a first draft comprising:
an offshore installation having
a securing mechanism arranged to push down on the vessel and increase a draft of the vessel from the first draft to a second draft; and
a vessel having
at least one ballasting tank, and
at least one port in fluid communication with the at least one ballasting tank arranged to selectively adjust a flow of ballast water in and out of the at least one ballasting tank;
wherein when the securing mechanism disengages from the vessel the vessel is arranged to rise from the second draft to the first draft, and
wherein when the vessel is at the first draft, the at least one port is arranged to empty at least part of the at least one ballasting tank.

19. A variable draft vessel comprising:
a deck arranged to receive a securing mechanism mounted on an offshore installation arranged to push down on the variable draft vessel and increase a draft of the variable draft vessel from a first draft to a second draft;
at least one ballasting tank; and
at least one port in fluid communication with the at least one ballasting tank arranged to selectively adjust a flow of ballast water in and out of the at least one ballasting tank;
wherein the at least one port is arranged to be below a waterline when the vessel is at the second draft and arranged to fill at least part of the at least one ballasting tank.

20. A variable draft vessel comprising:
a deck arranged to receive a securing mechanism mounted on an offshore installation arranged to push down on the variable draft vessel and increase a draft of the variable draft vessel from a first draft to a second draft;
at least one ballasting tank; and
at least one port in fluid communication with the at least one ballasting tank arranged to selectively adjust a flow of ballast water in and out of the at least one ballasting tank;
wherein when the securing mechanism disengages from the vessel the vessel is arranged to raise from the second draft to the first draft, and
wherein when the vessel is at the first draft, the at least one port is arranged to empty at least part of the at least one ballasting tank.
